(19) United States
(12) Patent Application Publication
(10) Pub. No.: US 2025/0162438 A1
(43) Pub. Date: May 22, 2025

(54) PARKING CONTROL DEVICE AND PARKING CONTROL METHOD

(71) Applicant: HONDA MOTOR CO., LTD., Tokyo (JP)

(72) Inventor: Seiichiro KONDO, Tokyo (JP)

(73) Assignee: HONDA MOTOR CO., LTD., Tokyo (JP)

(21) Appl. No.: 18/951,701

(22) Filed: Nov. 19, 2024

(30) Foreign Application Priority Data
Nov. 20, 2023 (JP) 2023-196764

(51) Int. Cl. B60L 53/36; B60L 53/12; B60L 53/38

(52) U.S. Cl. CPC B60L 53/36; B60L 53/12; B60L 53/38

(57) ABSTRACT

A parking control device for a vehicle capable of non-contact power transmission between a first coil disposed in a parking space and a second coil provided in the vehicle, the parking control device includes: a parking control unit configured to execute parking control for automatically parking the vehicle in a target parking position where the first coil and the second coil face each other in the parking space; and a result detection unit configured to detect transmission result information of the non-contact power transmission executed at the target parking position. The parking control unit is configured to store, in a storage unit, parking position information during execution of the non-contact power transmission in association with the transmission result information each time the non-contact power transmission is executed in the parking space, and offset the target parking position based on past parking position information and the transmission result information stored.

This application is based upon and claims the benefit of priority from prior Japanese patent application No. 2023-196764, filed on Nov. 20, 2023, the entire contents of which are incorporated herein by reference.

### TECHNICAL FIELD

The present disclosure relates to a parking control device and a parking control method for a vehicle capable of non-contact power transmission.

### BACKGROUND ART

In recent years, researches and developments have been conducted on charging and power feeding in a vehicle mounted with a secondary battery that contributes to an increase in energy efficiency in order to allow more users to access affordable, reliable, sustainable, and advanced energy.

For example, as researches and developments relating to charging and power feeding, researches and developments related to non-contact charging in which a battery mounted on a vehicle is charged in a non-contact manner have been conducted. For example, each of JP2019-9874A, JP2017-93129A, JP2014-207859A and JP2018-174690A discloses a non-contact power transmission system that transmits power from a primary coil (power transmission coil) of a non-contact charging equipment provided in a parking lot or the like to a secondary coil (power reception coil) provided in a vehicle in a non-contact manner.

Each of JP2019-9874A, JP2017-93129A, JP2014-207859A and JP2018-174690A proposes a technique for accurately aligning the primary coil and the secondary coil in order to efficiently perform non-contact charging.

### SUMMARY OF INVENTION

Incidentally, automated parking control in which a vehicle is automatically moved and parked in a predetermined parking space is known. According to the automated parking control, the vehicle may be automatically parked in a parking lot provided with the non-contact charging equipment with high reproducibility. However, due to variation in control, variation in detection of a relative position between the secondary coil and the vehicle, or the like, the parking position in the automated parking control is not always a position where efficiency of power transmission in a non-contact manner is optimal.

Aspects of the present disclosure relates to providing a parking control device and a parking control method capable of improving efficiency of non-contact power transmission in a case where a vehicle is parked by parking control in a parking position capable of non-contact power transmission.

According to an aspect of the present disclosure, there is provided a parking control device for a vehicle capable of non-contact power transmission in which power is transmitted in a non-contact manner between a first coil disposed in a parking space and a second coil provided in the vehicle, the parking control device including:
a parking control unit configured to execute parking control for automatically parking the vehicle in a target parking position where the first coil and the second coil face each other in the parking space; and
a result detection unit configured to detect transmission result information of the non-contact power transmission executed at the target parking position, in which
the parking control unit is configured to
   store, in a storage unit, parking position information of the vehicle during execution of the non-contact power transmission in association with the transmission result information each time the non-contact power transmission is executed in the parking space, and
   offset the target parking position of the parking control executed in the parking space based on past parking position information and the transmission result information stored in the storage unit.

According to another aspect of the present disclosure, there is provided a parking control method for a vehicle capable of non-contact power transmission in which power is transmitted in a non-contact manner between a first coil provided in a parking space and a second coil provided in the vehicle, the parking control method including:
executing parking control for automatically parking the vehicle in a target parking position where the first coil and the second coil face each other in the parking space;
detecting transmission result information of the non-contact power transmission executed at the target parking position;
storing, in a storage unit, parking position information of the vehicle during execution of the non-contact power transmission in association with the transmission result information each time the non-contact power transmission is executed in the parking space; and
offsetting the target parking position of the parking control to be executed in the parking space next time based on past parking position information and the transmission result information stored in the storage unit.

According to the aspects of the present disclosure, efficiency of non-contact power transmission may be improved in a case where a vehicle is parked by parking control in a parking position capable of non-contact power transmission, which further contributes to improvement in energy efficiency.

### BRIEF DESCRIPTION OF DRAWINGS

Exemplary embodiment(s) of the present invention will be described in detail based on the following figures, wherein:

FIG. 1 is a diagram illustrating an overall configuration of a non-contact power transmission system 1, and is a top view illustrating a state in which a vehicle 10 is being parked in a parking space 2 provided with a power transmission device 3;

FIG. 2 is a diagram illustrating the overall configuration of the non-contact power transmission system 1, and is a side view illustrating a state in which the vehicle 10 is parked in the parking space 2 and non-contact charging is being conducted;

FIG. 3 is a block diagram illustrating an internal configuration of the vehicle 10 equipped with a parking control device 30 according to an embodiment of the present disclosure;

FIG. 4 is a graph illustrating a deviation occurring between a target parking position in control and an optimal charging position where an efficiency of the non-contact charging is maximized;

FIG. 5 is a diagram illustrating an overview of processing of searching for the optimal charging position by the parking control device 30;

FIG. 6A is a graph illustrating a state in which the target parking position is offset in a Y direction and a position in the Y direction of the optimal charging position is searched;

FIG. 6B is a graph illustrating a state in which the target parking position is offset in an X direction and a position in the X direction of the optimal charging position is searched;

FIG. 7 is a flowchart illustrating an example of the processing of searching for the optimal charging position by the parking control device 30;

FIG. 8 is a flowchart illustrating an example of processing of Y direction searching processing S110;

FIG. 9 is a flowchart illustrating an example of processing of X direction searching processing S114; and

FIG. 10 is a graph illustrating a modification of the processing of searching for the optimal charging position by the parking control device 30.

### DESCRIPTION OF EMBODIMENTS

Hereinafter, a parking control device and a parking control method according to an embodiment of the present disclosure will be described with reference to the accompanying drawings.

### Non-Contact Power Transmission System

A non-contact power transmission system of the present embodiment is a system capable of non-contact power transmission in which power is transmitted in a non-contact manner between a vehicle and an equipment provided in a predetermined parking space. The non-contact power transmission includes one of power transmission from an equipment provided in the parking space to the vehicle (non-contact charging) and power transmission from the vehicle to an equipment (non-contact power feeding). In the following, a case in which the vehicle performs non-contact charging will be described as an example of the non-contact power transmission.

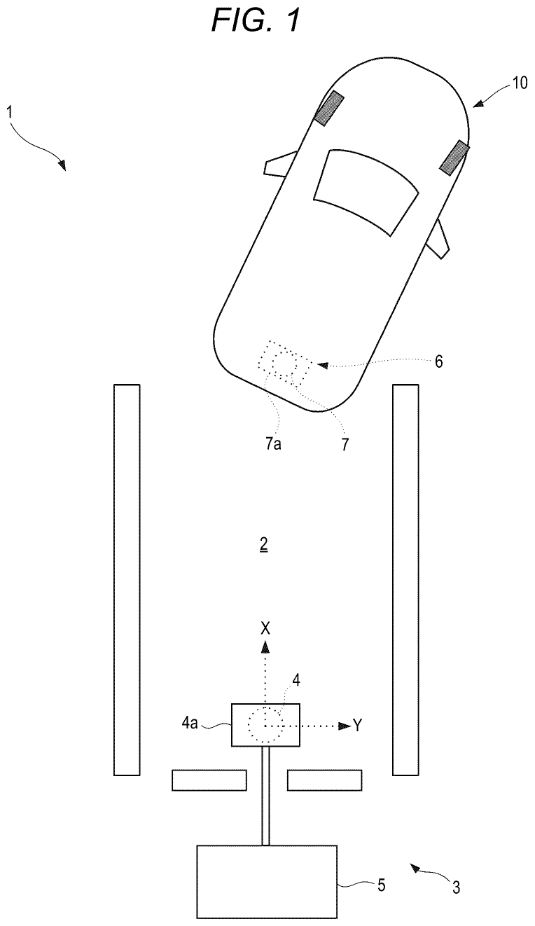

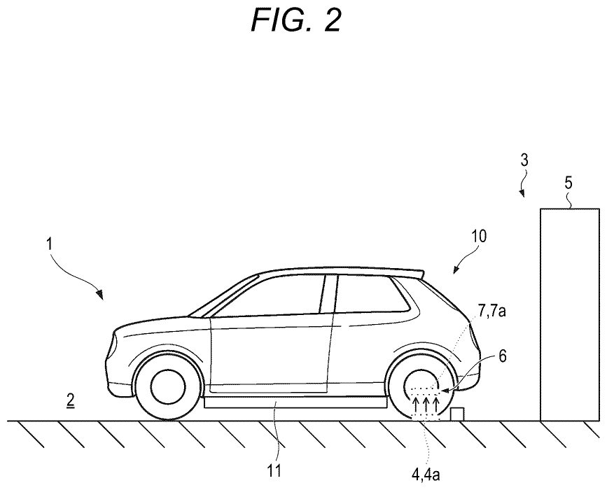

As illustrated in FIGS. 1 and 2, the non-contact power transmission system 1 includes a power transmission device 3 installed in a predetermined parking space 2, and a power reception device 6 provided in the vehicle 10 and configured to receive power transmitted from the power transmission device 3 in a non-contact manner. The non-contact power transmission system 1 supplies power from the power transmission device 3 to the power reception device 6 using, for example, magnetic coupling between coils, such as a magnetic field resonance method or an electromagnetic induction method, or an electric field resonance method. In this way, non-contact charging of a battery 11 mounted on the vehicle 10 is possible.

The power transmission device 3 includes a primary coil 4 provided on a ground of the parking space 2 in a state covered by a pad 4a for example and transmitting AC power, and a power supply unit 5 connected to an external power system such as a commercial power supply. A shape of the primary coil 4 is, for example, circular in a plan view, but is not limited thereto and may be elliptical, square, rectangular, or the like.

The power reception device 6 includes a secondary coil 7 provided under a floor of the vehicle 10 in a state covered by a pad 7a for example and receiving the AC power transmitted from the power transmission device 3 in a non-contact manner, and a rectifier (not illustrated) that rectifies the received AC power and supplies the rectified AC power to the battery 11. A shape of the secondary coil 7 is, for example, circular in a plan view, but is not limited thereto and may be elliptical, square, rectangular, or the like.

The vehicle 10 is, for example, an electric vehicle such as a battery type electric automobile or a plug-in hybrid vehicle, and receives power transmitted from the power transmission device 3 by the power reception device 6 and stores the power in the battery 11 such as a lithium ion battery or a nickel hydrogen battery. The vehicle 10 is configured to travel by driving a motor (not illustrated), which is a drive source, by using the power stored in the battery 11. When the vehicle 10 is parked at a position where the secondary coil 7 of the vehicle faces the primary coil 4 of the power transmission device 3, AC power is supplied from the power supply unit 5 to the primary coil 4, and non-contact power transmission is performed from the primary coil 4 to the secondary coil 7.

### Internal Configuration of Vehicle

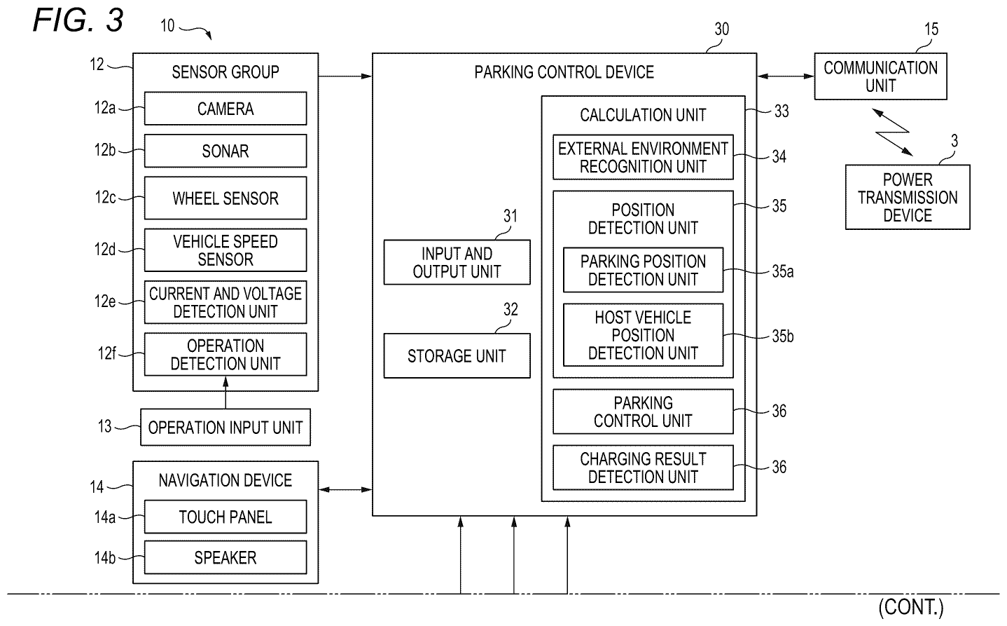

As illustrated in FIG. 3, the vehicle 10 includes a sensor group 12, an operation input unit 13, a navigation device 14, a communication unit 15, a parking control device 30, an electric power steering system 40 (also referred to as EPS system 40), a driving force control system 50, and a braking force control system 60.

The sensor group 12 acquires various detection values used for control and the like by the parking control device 30. The sensor group 12 includes, for example, a camera 12a, a sonar 12b, a wheel sensor 12c, a vehicle speed sensor 12d, a current and voltage detection unit 20 12e, and an operation detection unit 12f.

The camera 12a acquires recognition data (for example, a peripheral image) for recognizing external environment of the vehicle 10 by imaging a periphery of the vehicle 10. The camera 12a includes, for example, a front camera, a rear camera, a left side camera, and a right side camera, and captures a front image, a rear image, a left side image, and a right side image as the peripheral image. Note that the number of cameras 12a may be any number, and for example, the left side camera and the right side camera may not be provided.

The sonar 12b emits a sound wave to the periphery of the vehicle 10, and receives a reflected sound from another object. A plurality of sonars 12b are provided, for example, in front, rear, left, and right sides of the vehicle 10.

The wheel sensor 12c detects a rotation angle of a wheel of the vehicle 10. The wheel sensor 12c includes, for example, a left rear wheel sensor that detects a rotation angle of a left rear wheel and a right rear wheel sensor that detects a rotation angle of a right rear wheel. The wheel sensor 12c may be implemented by an angle sensor or a displacement sensor. The wheel sensor 12c outputs a detection pulse each time the wheel is rotated by a predetermined angle. The detection pulse output from the wheel sensor 12c is used to calculate the rotation angle and a rotation speed of the wheel. A movement distance of the vehicle 10 is calculated based on the rotation angle of the wheel.

The vehicle speed sensor 12d detects a speed of the vehicle 10. The vehicle speed sensor 12d detects a speed of the vehicle 10 based on, for example, rotation of a transmission countershaft.

The current and voltage detection unit 12e is provided in the power reception device 6, and detects a current value and a voltage value of power (hereinafter also referred to as charging power) received by the secondary coil 7 during non-contact charging.

The operation detection unit 12f detects an operation content of a user performed by using the operation input unit 13. The operation input unit 13 includes various user interfaces such as a side mirror switch that switches between open and closed states of a side mirror, and a shift lever (a selector lever or a selector).

The navigation device 14 detects a current position of the vehicle 10 using, for example, a global positioning system (GPS), and guides the user along a route to a destination. The navigation device 14 includes a storage device (not illustrated) including a map information database.

The navigation device 14 includes a touch panel 14a and a speaker 14b. The touch panel 14a is configured by integrating a display device (for example, a liquid crystal display) capable of displaying images and an input device capable of receiving information input, and functions as a display device and an input device of the parking control device 30. The user may input a request to execute parking control for automatically parking the vehicle 10 in the predetermined parking space 2 via the touch panel 14a. The speaker 14b outputs various types of guidance by voice under the control of the parking control device 30.

The communication unit 15 is a communication interface that performs communication with an external device. The external device is, for example, a communication unit (not illustrated) provided in the power transmission device 3, and the parking control device may communicate with the communication unit of the power transmission device 3 via the communication unit 15. For example, a mobile communication network such as a cellular line, Wi-Fi (registered trademark), or Bluetooth (registered trademark) may be adopted for the communication between the vehicle 10 and the external device.

The EPS system 40 includes a steering angle sensor 41, a torque sensor 42, an EPS motor 43, a resolver 44, and an EPS electronic control unit (ECU) 45. The steering angle sensor 41 detects a steering angle θst of a steering wheel 46. The torque sensor 42 detects a torque TQ applied to the steering wheel 46. The EPS motor 43 applies a driving force or a reaction force to a steering column 47 coupled to the steering wheel 46, thereby enabling assistance to the occupant in operating the steering wheel 46 and automatic steering of the steering wheel 46 during parking control. The resolver 44 detects a rotation angle θm of the EPS motor 43. The EPS ECU 45 controls the entire EPS system 40.

The driving force control system 50 includes a driving ECU 51, and executes driving force control for the vehicle 10. The driving ECU 51 controls a driving force of the vehicle 10 by controlling a motor, an internal combustion engine, or the like, which is a drive source of the vehicle 10, based on an accelerator operation by the user on an accelerator pedal 52 and an instruction from the parking control device 30.

The braking force control system 60 includes a braking ECU 61, and executes braking force control for the vehicle 10. The braking ECU 61 controls a braking force of the vehicle 10 by controlling a brake mechanism or the like based on a brake operation by the user on a brake pedal 62 and an instruction from the parking control device 30.

The parking control device 30 includes an input and output unit 31, a storage unit 32, and a calculation unit 33. The calculation unit 33 is implemented by, for example, a central processing unit (CPU). The calculation unit 33 executes various types of control by controlling units based on a program stored in the storage unit 32. The calculation unit 33 receives and outputs signals from and to units connected to the parking control device 30 via the input and output unit 31.

The calculation unit 33 includes an external environment recognition unit 34 that acquires recognition data of an external environment of the vehicle 10, a position detection unit that detects a target parking position and a host vehicle position with respect to the target parking position based on the recognition data, a parking control unit 36 that performs parking control to move the vehicle 10 to the target parking position by automatic steering, and a charging result detection unit 37 that detects charging result information (an example of “transmission result information” in the present disclosure) such as a charging power during non-contact charging and a charging efficiency, which is a ratio of power transmitted by the power transmission device 3 to the charging power.

The external environment recognition unit 34 acquires the peripheral image of the vehicle 10 captured by the camera 12a (that is, recognition data of the external environment). The external environment recognition unit 34 may acquire the recognition data of the external environment of the vehicle 10 acquired by the sonar 12b, a radar (not illustrated), or the like.

The position detection unit 35 includes a parking position detection unit 35a and a host vehicle position detection unit 35b. The parking position detection unit 35a detects the target parking position in the parking space 2 based on the recognition data of the external environment acquired by the camera 12a. The target parking position is a position where the primary coil 4 and the secondary coil 7 face each other. More specifically, the target parking position is a position where a center of the primary coil 4 and a center of the secondary coil 7 coincide with each other in a top view, in other words, a position where a relative distance between the center of the primary coil 4 and the center of the secondary coil 7 in a horizontal direction is zero. When the relative distance is zero, the charging power during non-contact charging is maximized, and the charging efficiency is maximized.

Specifically, the parking position detection unit 35a detects the position where the relative distance between the center of the primary coil 4 and the center of the secondary coil 7 becomes zero, as the target parking position, based on recognition data relating to a white line (or an obstacle such as an outer wall) partitioning the parking space 2 acquired by the camera 12a, a curb, the primary coil 4 (the pad 4a) provided on the ground, or the like.

When the parking space 2 is a parking space with a high parking frequency such as a parking lot of home or a parking lot paid by month, the parking space 2 may be stored in the storage unit 32 as a parking space with a high parking frequency, for example, based on a request from the user via the touch panel 14a. In this case, the parking position detection unit 35a stores the recognition data of the primary coil 4 acquired by the external environment recognition unit 34 and recognition data of features around the parking space 2 in the storage unit 32. The features around the parking space 2 include characteristic buildings and obstacles present around the parking space 2. Accordingly, the next time or thereafter the vehicle 10 is parked in the parking space 2, the user may easily perform a request of parking control to the parking space 2 via the touch panel 14a or the parking control may be automatically performed when the vehicle 10 approaches the parking space 2.

The host vehicle position detection unit 35b detects a host vehicle position which is a current relative position of the vehicle 10 with respect to the target parking position detected by the parking position detection unit 35a. Specifically, the host vehicle position detection unit 35b detects the host vehicle position based on the recognition data of the primary coil 4 acquired by the external environment recognition unit 34 and the recognition data of the features around the parking space 2.

The parking control unit 36 performs parking control for the vehicle 10 by the automatic steering of the steering wheel 46. In the parking control, operations on the steering wheel 46, the accelerator pedal 52, the brake pedal 62 and the like are automatically performed. The parking control unit 36 automatically moves the vehicle 10 to the target parking position of the parking space 2 and parks the vehicle 10 based on the recognition data of the external environment recognized by the external environment recognition unit 34, and the target parking position and the host vehicle position detected by the position detection unit 35.

The charging result detection unit 37 detects the charging result information of non-contact charging based on a current value and a voltage value acquired by a current and voltage sensor (not illustrated) provided in the power reception device 6. The charging result information includes the charging power and the charging efficiency described above.

### Searching of Optimal Charging Position by Parking Control Device

The parking control executed by the parking control device 30 enables the vehicle 10 to be parked at the target parking position of the parking space 2 with a high reproducibility. On the other hand, even when the parking control device 30 determines that the vehicle 10 is parked at the target parking position, that is, the position where the relative distance between the center of the primary coil 4 and the center of the secondary coil 7 in the horizontal direction becomes zero, due to variation in the control executed by the parking control unit 36, variation in the detection results of the position detection unit 35, the peripheral environment, and the like, in reality, deviation may occur between the center of the primary coil 4 and the center of the secondary coil 7, and the relative distance in the horizontal direction may not be zero. In this case, the charging power and the charging efficiency of non-contact charging cannot be maximized.

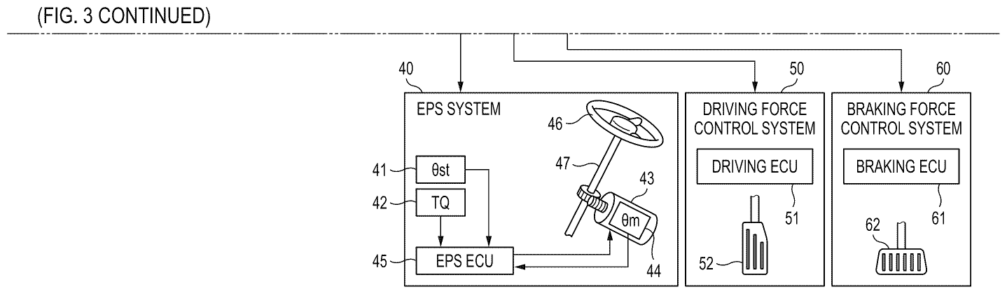

FIG. 4 is a graph illustrating the deviation occurring between the center of the primary coil 4 and the center of the secondary coil 7. As illustrated in FIG. 1, the X direction in FIG. 4 is an entry and exit direction into the parking space 2, and the Y direction is a direction perpendicular to the X direction. A horizontal axis and a vertical axis in FIG. 4 respectively indicate an actual deviation amount in the X direction (also referred to as an actual X deviation amount) and an actual deviation amount in the Y direction (also referred to as an actual Y deviation amount) of the center of the secondary coil 7 with respect to the center of the primary coil 4 when parking of the vehicle 10 at the target parking position of the parking space 2 is completed by the parking control. When the actual X deviation amount and the actual Y deviation amount are both zero, the relative distance between the center of the primary coil 4 and the center of the secondary coil 7 in the horizontal direction is zero, and therefore the charging power and the charging efficiency in non-contact charging are maximized. A position (0, 0) where the actual X deviation amount and the actual Y deviation amount become zero is also referred to as an optimal charging position. On the other hand, when the relative distance between the center of the primary coil 4 and the center of the secondary coil 7 in the horizontal direction increases, the charging power and the charging efficiency gradually decrease.

In the parking control according to the parking control device 30, even when it is determined that the deviation amount in the X direction and the deviation amount in the Y direction are both zero in the control, the actual X deviation amount and the actual Y deviation amount may occur due to the above-described control variation and the like. In the example illustrated in FIG. 4, when parking to the target parking position in the parking space 2 is completed by the parking control, the center of the secondary coil 7 is deviated by −10 mm from the center of the primary coil 4 in the X direction, and the center of the secondary coil 7 is deviated by +20 mm from the center of the primary coil 4 in the Y direction. When the target parking position in the control deviates from the actual optimal charging position, the charging power and the charging efficiency of non-contact charging are not maximized.

Then, each time the parking control and the non-contact charging are executed in the specific parking space 2, the parking control device 30 performs offset processing on the target parking position and offsets the target parking position to the optimal charging position. Specifically, each time the parking control and the non-contact charging are executed in the parking space 2, the parking control device 30 stores the parking position information in association with the charging result information of the vehicle 10 in the storage unit 32 when the non-contact charging is executed. Then, the parking control device 30 offsets the target parking position of the parking control executed in the parking space 2 based on the past parking position information and the charging result information stored in the storage unit 32.

More specifically, when the vehicle 10 is parked at the target parking position of the parking space 2 by the parking control and performs the non-contact charging, the parking control unit 36 offsets the target parking position of the parking control executed next time in the parking space 2 by a predetermined distance (hereinafter also referred to as an offset amount). Each time the parking control and the non-contact charging are executed in the parking space 2, the parking control device 30 stores the offset amount and the charging result information in the storage unit 32 in association with each other. Then, the parking control device 30 searches for the optimal charging position in the parking space 2 based on the offset amount and the charging result information stored in the storage unit 32, and sets the target parking position at the optimal charging position.

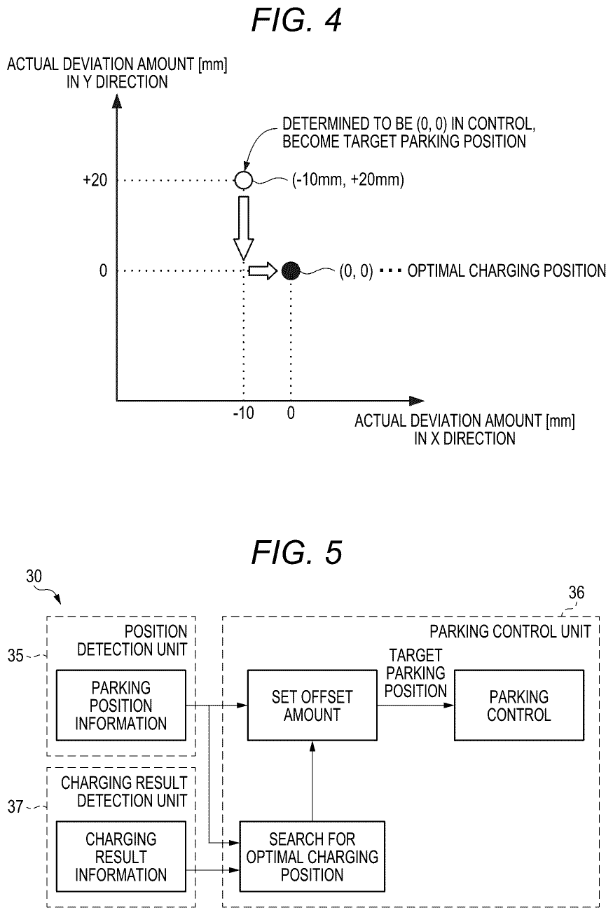

FIG. 5 shows an outline of processing of searching for the optimal charging position executed by the parking control device 30. Each time the parking control and the non-contact charging are executed in the parking space 2, the parking control unit 36 acquires the parking position information and the charging result information from the position detection unit 35 and the charging result detection unit 37, respectively, and stores the acquired information in the storage unit 32. The parking position information acquired from the position detection unit 35 is, for example, information related to the target parking position including the offset amount.

The parking control unit 36 searches for the optimal charging position based on the parking position information and the charging result information stored in the storage unit 32. The parking control unit 36 sets the offset amount obtained by searching for the target parking position so that the target parking position of the parking control in the parking space 2 coincides with the optimal charging position. In this way, the parking control unit 36 may park the vehicle 10 at the optimal charging position by the parking control in the parking space 2.

The processing of searching for the optimal charging position will be described in more detail. In the present embodiment, the parking control unit 36 executes the offset processing in the X direction and the offset processing in the Y direction separately. Specifically, the parking control unit 36 first offsets the target parking position only in a first direction (for example, the Y direction) which is one direction of the X direction and the Y direction to search for the position in the first direction of the optimal charging position, and after searching for the position in the first direction of the optimal charging position, offsets the target parking position in a second direction (for example, the X direction) which is the other direction to search for the position in the second direction of the optimal charging position.

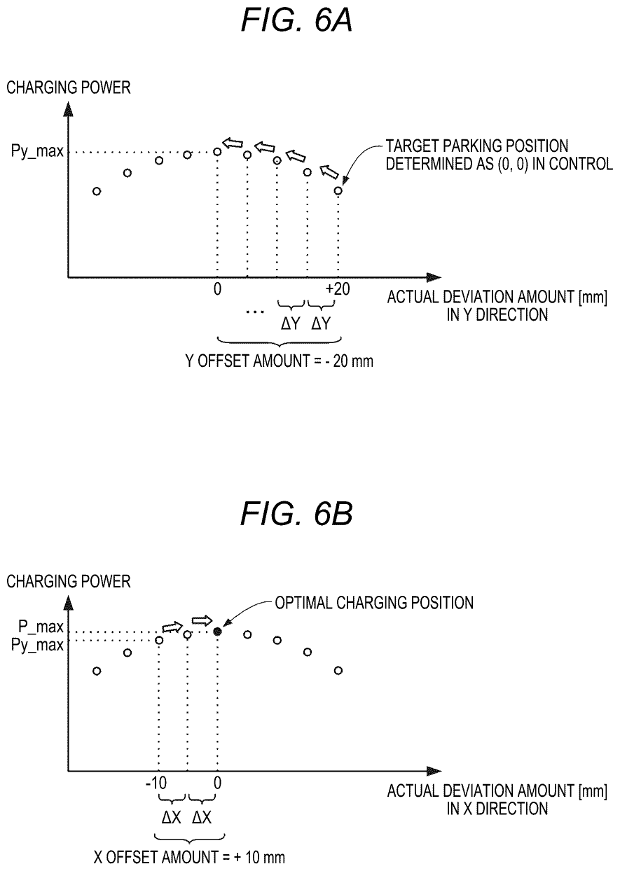

As illustrated in FIG. 6A, the parking control unit 36 offsets the target parking position, which is a position where it is determined that the deviation amount in the X direction and the deviation amount in the Y direction are both zero in the control, by ΔY (for example, 2 mm) to a negative side in the Y direction each time the parking control and the non-contact charging are performed in the parking space 2. Then, the parking control unit 36 searches for a position where the charging power becomes a maximum value Py_max in the Y direction, that is, a position where the actual Y deviation amount becomes zero. Note that although FIGS. 6A and 6B show an example of searching for a position where the charging power is at a maximum value, the parking control unit 36 may search for a position where the charging efficiency is at a maximum value.

After searching for the position in the Y direction of the optimal charging position, as shown in FIG. 6B, the parking control unit 36 offsets the target parking position by ΔX (for example, 2 mm) to a positive side in the X direction each time the parking control and the non-contact charging are executed in the parking space 2. Then, the parking control unit 36 searches for a position where the charging power becomes the maximum value in the X direction, that is, a position where the actual X deviation amount becomes zero. A position where the actual Y deviation amount and the actual X deviation amount become zero is the optimal charging position, and the charging power becomes a maximum value P_max.

In this way, the parking control unit 36 may search for the optimal charging position with a simple algorithm by performing the offset processing in the order of the Y direction and the X direction, specifically, each time for one direction.

Note that when the parking control and the non-contact charging are executed for the first time in the parking space 2, the parking control unit 36 first offsets the target parking position to a positive side in the Y direction, for example, since the direction in which the target parking position on the control is positioned with respect to the optimal charging position is unknown. When the charging power decreases, the positive side is estimated as a direction in which the actual Y deviation amount increases, and in the next non-contact charging, the target parking position is offset to the negative side in the Y direction. The same applies to the X direction.

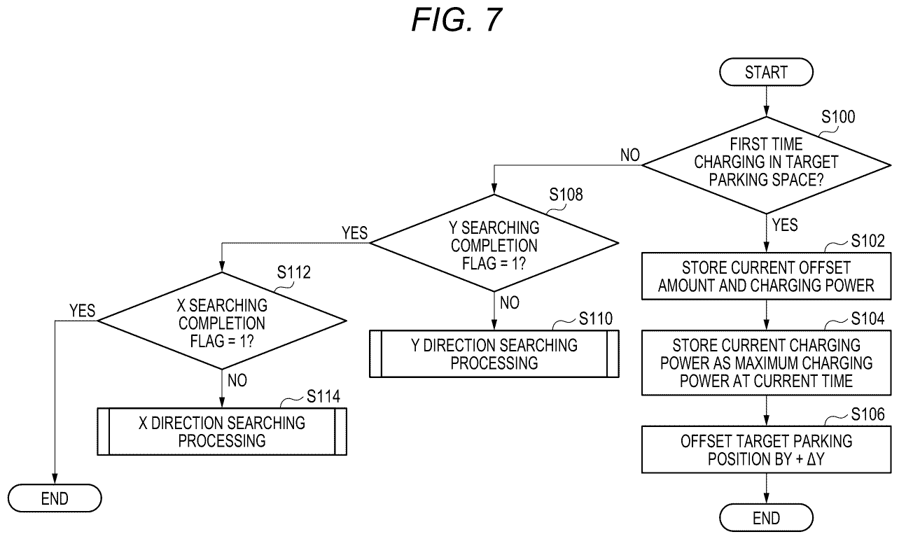

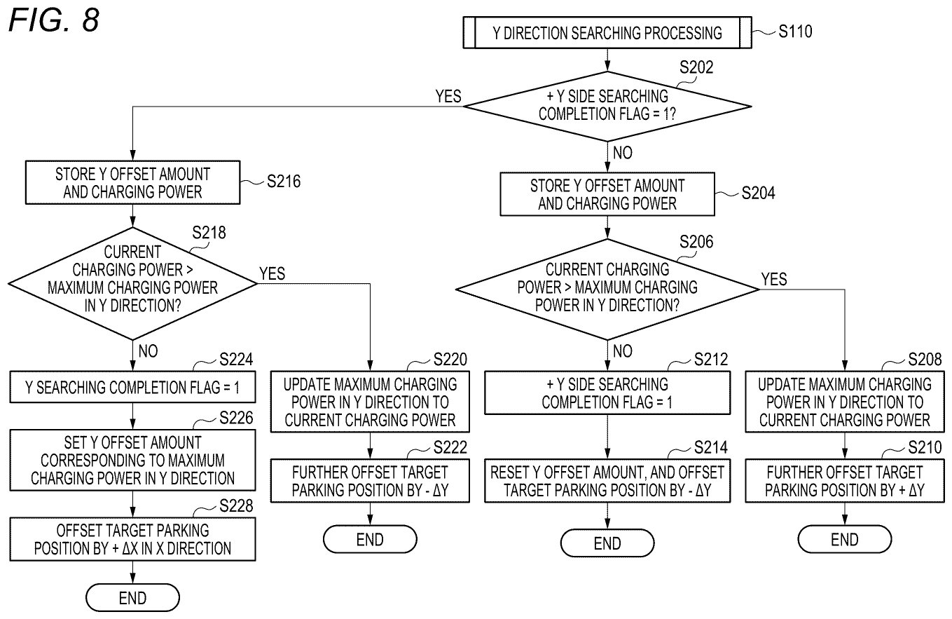

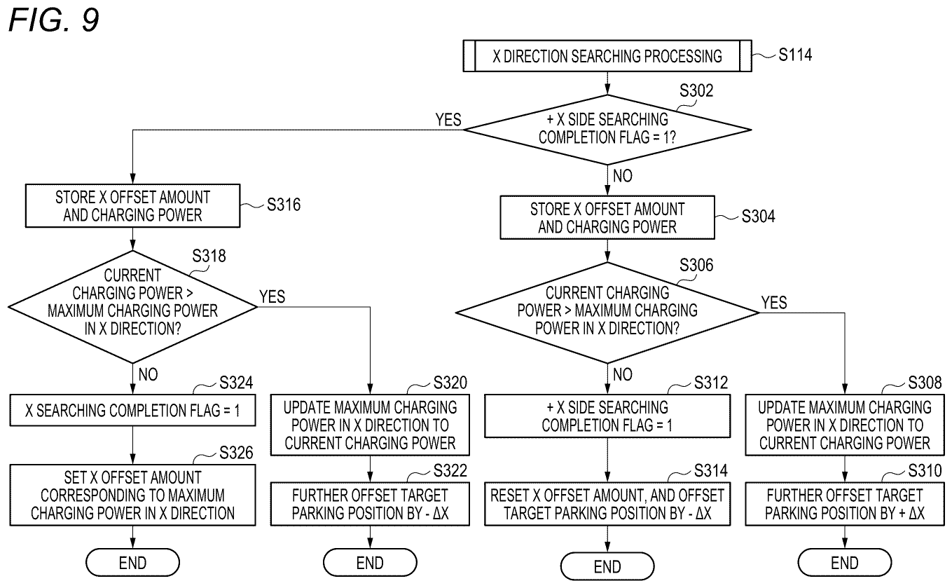

Next, an example of processing of searching for the optimal charging position by the parking control device 30 will be described with reference to a flowchart shown in FIGS. 7 to 9. The parking control device 30 repeatedly executes this flowchart each time the parking control and the non-contact charging are executed in the parking space 2. Note that although this flowchart shows an example of searching for a position where the charging power is at the maximum value, the parking control device 30 may search for a position where the charging efficiency is at a maximum value.

The parking control device 30 first determines whether the current non-contact charging is performed for the first time on the target parking space 2 (step S100). For example, if the charging result information and the target parking position when the non-contact charging is performed in the parking space 2 in the past are stored in association with each other in the storage unit 32, the parking control device 30 determines that the current non-contact charging is not that performed for the first time in this parking space 2.

When it is determined that the current non-contact charging is performed for the first time in the parking space 2 (step S100: YES), the parking control device 30 stores the current offset amount in association with the charging power in the storage unit 32 (step S102). Here, the offset amount includes an X offset amount which is a predetermined distance in the X direction and a Y offset amount which is a predetermined distance in the Y direction. Since the current non-contact charging is performed in the parking space 2 for the first time, and no offset processing is performed in the past, the X offset amount and the Y offset amount are stored in the storage unit 32 as zero.

The parking control device 30 stores the current charging power in the storage unit 32 as the maximum charging power at a current time (step S104). Since the current non-contact charging is performed in the parking space 2 for the first time, the current charging power is the maximum charging power at the current time.

The parking control device 30 offsets the target parking position by ΔY to the positive side in the Y direction (step S106). In this way, the next time the vehicle 10 is automatically parked in the parking space 2, the target parking position is offset to the positive side in the Y direction. Then, the parking control device 30 ends the current flowchart.

When the parking control and the non-contact charging are performed for the second and subsequent times in the target parking space 2, the parking control device 30 determines that the current parking control and non-contact charging are not those performed for the first time in this target parking space 2 (step S100: NO), and determines whether a Y searching completion flag is 1 (step S108). When searching of the position in the Y direction of the optimal charging position is completed in Y direction searching processing S110 described later, the Y searching completion flag is 1, and when the searching is not completed, the Y searching completion flag is 0. When the Y searching completion flag is not 1 (step S108: NO), the processing proceeds to the Y direction searching processing S110.

In the Y direction searching processing S110, first, the parking control device 30 determines whether a +Y side searching completion flag is 1 (step S202). When the target parking position in the control is offset to the positive side in the Y direction and the searching for the position in the Y direction of the optimal charging position is completed, and when the target parking position in the control is offset to the positive side in the Y direction and it is estimated that the position in the Y direction of the optimal charging position is not on the positive side but on the negative side, the +Y side searching completion flag is 1.

When the +Y side searching completion flag is not 1 (step S202: NO), the parking control device 30 stores the Y offset amount and the charging power of the current parking control and non-contact charging in association with each other in the storage unit 32 (step S204). When the parking control and the non-contact charging are executed for the second time in the parking space 2, the Y offset amount is +ΔY set in step S106, and the charging power is the charging power detected in the current non-contact charging.

Next, the parking control device 30 determines whether the current charging power is larger than a maximum charging power in the Y direction stored in the storage unit 32 before the current time (step S206). The maximum charging power in the Y direction is a maximum value of the charging powers stored in association with the Y offset amount, and when the parking control and the non-contact charging is executed for the second time in the parking space 2, the maximum charging power (that is, the charging power for the first time) stored in step S104 becomes the maximum charging power in the Y direction.

When the current charging power is larger than the maximum charging power in the Y direction (step S206: YES), the maximum charging power in the Y direction is updated to the current charging power, and the current Y offset amount and the maximum charging power in the Y direction are stored in association with each other (step S208).

The parking control device 30 further offsets the target parking position to the positive side by ΔY (step S210). In this way, the next time the vehicle 10 is automatically parked in the parking space 2, the target parking position is further offset to the positive side in the Y direction. For example, when the parking control and the non-contact charging in the parking space 2 are executed for the second time, the Y offset amount is +ΔY×2. Then, the parking control device ends the current flowchart. Each time the parking control and the non-contact charging are executed in the parking space 2 until the detected charging power becomes equal to or less than the maximum charging power in the Y direction, the parking control device 30 repeatedly executes steps S204 to S210 to increase the Y offset amount on the positive side, and searches for the position in the Y direction of the optimal charging position.

When the current charging power is equal to or less than the maximum charging power in the Y direction (step S206: NO), the parking control device 30 sets the +Y side searching completion flag to 1 (step S212). That is, when the current charging power is equal to or less than the maximum charging power in the Y direction stored in the past, it is estimated that the charging power decreases even if the target parking position is further offset to the positive side in the Y direction, and therefore the searching on the positive side of the Y direction is ended.

After the +Y side searching completion flag is set to 1, the parking control device 30 resets the Y offset amount, and offsets the next target parking position by ΔY to the negative side (step S214). Accordingly, the Y offset amount is −ΔY. Then, the parking control device 30 ends the current flowchart. Note that the Y offset amount stored in the storage unit 32 in the past and the charging power corresponding thereto are held without being deleted.

When the +Y side searching completion flag is 1 (step S202: YES), the parking control device 30 stores the Y offset amount and the charging power of the current parking control and non-contact charging in association with each other in the storage unit 32 (step S216). When step S216 is executed for the first time after the +Y side searching completion flag becomes 1 in step S212, the Y offset amount is −ΔY set in step S214, and the charging power is a charging power detected in the current non-contact charging.

Next, the parking control device 30 determines whether the current charging power is larger than the maximum charging power in the Y direction stored in the storage unit 32 before the current time (step S218). Here, the maximum charging power in the Y direction is one of the maximum charging power stored in step S104, the maximum charging power stored in step S208, and a maximum charging power stored in the storage unit 32 in step S220 described later.

When the current charging power is larger than the maximum charging power in the Y direction (step S218: YES), the maximum charging power in the Y direction is updated to the current charging power, and the current Y offset amount and the maximum charging power in the Y direction are stored in association with each other (step S220).

The parking control device 30 further offsets the target parking position to the negative side by ΔY (step S222). In this way, when the vehicle 10 is automatically parked in the parking space 2 for the next time, the target parking position is further offset to the negative side in the Y direction. Then, the parking control device 30 ends the current flowchart. Each time the parking control and the non-contact charging are executed in the parking space 2 until the detected charging power becomes equal to or less than the maximum charging power in the Y direction, the parking control device 30 repeatedly executes steps S216 to S222 to increase the Y offset amount on the negative side, and searches for the position in the Y direction of the optimal charging position.

When the current charging power is equal to or less than the maximum charging power in the Y direction (step S218: NO), the parking control device 30 sets the Y searching completion flag to 1 (step S224). That is, when the current charging power is equal to or less than the maximum charging power in the Y direction stored in the past, it is estimated that the charging power decreases even if the target parking position is further offset to the negative side in the Y direction, and therefore the searching on the negative side of the Y direction is ended.

The parking control device 30 sets the Y offset amount corresponding to the maximum charging power in the Y direction stored in the storage unit 32 as the Y offset amount of the target parking position when the vehicle 10 is automatically parked in the parking space 2 after the next time (step S226). For example, in the example illustrated in FIG. 6A, the Y offset amount is set to −20 mm, which is a Y offset amount corresponding to the maximum charging power Py_max in the Y direction.

The parking control device 30 offsets the target parking position by ΔX to the positive side in the X direction (step S228). In this way, when the vehicle 10 is automatically parked in the parking space 2 for the next time, the target parking position is offset to the positive side in the X direction. Then, the parking control device 30 ends the current flowchart.

When the Y searching completion flag is 1 in step S224, the processing proceeds to a YES direction in step S108, and the parking control unit 36 determines whether an X searching completion flag is 1 (step S112). For the X searching completion flag, when searching of the position in the X direction of the optimal charging position is completed in X direction searching processing S114 described later, the X searching completion flag is 1, and when the searching is not completed, the X searching completion flag is 0. When the X searching completion flag is not 1 (step S112: NO), the processing proceeds to the X direction searching processing S114.

In the X direction searching processing S114, first, the parking control device 30 determines whether a +X side searching completion flag is 1 (step S302). When the target parking position in the control is offset to the positive side in the X direction and the searching for the position in the X direction of the optimal charging position is completed, and when the target parking position in the control is offset to the positive side in the X direction and it is estimated that the position in the X direction of the optimal charging position is not on the positive side but on the negative side, the +X side searching completion flag is 1.

When the +X side searching completion flag is not 1 (step S302: NO), the parking control device 30 stores the X offset amount and the charging power of the current parking control and non-contact charging in association with each other in the storage unit 32 (step S304). When the X direction searching processing S114 is executed for the first time, the X offset amount is +ΔX set in step S228, and the charging power is a charging power detected in the current non-contact charging.

Next, the parking control device 30 determines whether the current charging power is larger than the maximum charging power in the X direction stored in the storage unit 32 before the current time (step S306). The maximum charging power in the X direction is a maximum value of the charging powers stored in association with the X offset amount. When the X direction searching processing S114 is executed for the first time, the maximum charging power in the Y direction that is searched in the Y direction searching processing S110 becomes the maximum charging power in the X direction (the X offset amount under this case is zero).

When the current charging power is larger than the maximum charging power in the X direction (step S306: YES), the maximum charging power in the X direction is updated to the current charging power, and the current X offset amount and the maximum charging power in the X direction are stored in association with each other (step S308).

The parking control device 30 further offsets the target parking position to the positive side by ΔX (step S310). In this way, the next time the vehicle 10 is automatically parked in the parking space 2, the target parking position is further offset to the positive side in the X direction. For example, when the X direction searching processing S114 is executed for the first time, the X offset amount is +ΔX×2. Then, the parking control device 30 ends the current flowchart. Each time the parking control and the non-contact charging are executed in the parking space 2 until the detected charging power becomes equal to or less than the maximum charging power in the X direction, the parking control device 30 repeatedly executes steps S304 to S310 to increase the X offset amount on the positive side, and searches for the position in the X direction of the optimal charging position.

When the current charging power is equal to or less than the maximum charging power in the X direction (step S306: NO), the parking control device 30 sets the +X side searching completion flag to 1 (step S312). That is, when the current charging power is equal to or less than the maximum charging power in the X direction stored in the past, it is estimated that the charging power decreases even if the target parking position is further offset to the positive side in the X direction, and therefore the searching on the positive side of the X direction is ended.

After the +X side searching completion flag is set to 1, the parking control device 30 resets the X offset amount, and offsets the next target parking position by ΔX to the negative side (step S314). Accordingly, the X offset amount is −ΔX. Then, the parking control device 30 ends the current flowchart. Note that the X offset amount stored in the storage unit 32 in the past and the charging power corresponding thereto are held without being deleted.

When the +X side searching completion flag is 1 (step S302: YES), the parking control device 30 stores the X offset amount and the charging power of the current parking control and non-contact charging in association with each other in the storage unit 32 (step S316). When step S316 is executed for the first time after the +X side searching completion flag becomes 1 in step S312, the X offset amount is −ΔX set in step S314, and the charging power is a charging power detected in the current non-contact charging.

Next, the parking control device 30 determines whether the current charging power is larger than the maximum charging power in the X direction stored in the storage unit 32 before the current time (step S318). Here, the maximum charging power in the X direction is one of the maximum charging power set in the Y direction searching processing S110, the maximum charging power stored in the storage unit 32 in step S308, and a maximum charging power stored in the storage unit 32 in step S320 described later.

When the current charging power is larger than the maximum charging power in the X direction (step S318: YES), the maximum charging power in the X direction is updated to the current charging power, and the current X offset amount and the maximum charging power in the X direction are stored in association with each other (step S320).

The parking control device 30 further offsets the target parking position to the negative side by ΔX (step S322). In this way, the next time the vehicle 10 is automatically parked in the parking space 2, the target parking position is further offset to the negative side in the X direction. Then, the parking control device 30 ends the current flowchart. Each time the parking control and the non-contact charging are executed in the parking space 2 until the detected charging power becomes equal to or less than the maximum charging power in the X direction, the parking control device 30 repeatedly executes steps S316 to S322 to increase the X offset amount on the negative side, and searches for the position in the X direction of the optimal charging position.

When the current charging power is equal to or less than the maximum charging power in the X direction (step S318: NO), the parking control device 30 sets the X searching completion flag to 1 (step S324). That is, when the current charging power is equal to or less than the maximum charging power in the X direction stored in the past, it is estimated that the charging power decreases even if the target parking position is further offset to the negative side in the X direction, and therefore the searching on the negative side of the X direction is ended.

The parking control device 30 sets the X offset amount corresponding to the maximum charging power in the X direction stored in the storage unit 32 as the X offset amount of the target parking position when the vehicle 10 is automatically parked in the parking space 2 after the next time (step S326). For example, in the example illustrated in FIG. 6B, the X offset amount is set to +10 mm which is the X offset amount corresponding to the maximum charging power P_max. Therefore, the X direction searching processing in the parking space 2 is ended, and the parking control device 30 ends the current flowchart.

As described above, the Y offset amount and the X offset amount in the parking space 2 may be set by the Y direction searching processing and the X direction searching processing, and the target parking position may be calibrated so as to coincide with the optimal charging position. Accordingly, the efficiency of the non-contact charging may be improved.

For example, the searching of the optimal charging position may be performed when the power transmission device 3 is installed in the parking space 2 at home or the like. Specifically, when the power transmission device 3 is installed in the parking space 2, the parking control and the non-contact charging by the parking control device 30 may be repeatedly executed, and the X offset amount and the Y offset amount may be searched based on the above-described flowchart. Accordingly, it is possible to obtain the effect of improving the efficiency of the non-contact charging by searching for the optimal charging position immediately after the power transmission device 3 is installed.

### Modification

The offset processing in the X direction and the offset processing in the Y direction by the parking control device 30 are separately executed in the above-described embodiment, but may be executed simultaneously.

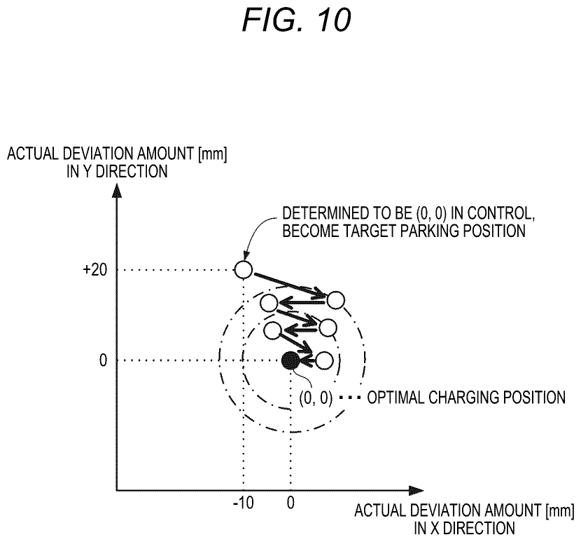

As indicated by a bold arrow in FIG. 10, the parking control device 30 may offset the target parking position of the parking control executed next time in the parking space 2 simultaneously in the X direction and the Y direction. Under this case, based on the matter that the charging power during non-contact charging is equal on a line (dashed line in the drawing, also referred to as an equal power line) connected in an approximately circular shape centered on the optimal charging position, each time the parking control and non-contact charging are executed in the parking space 2, the target parking position in the control is offset simultaneously in the X direction and the Y direction so as to approach the optimal charging position. According to such a configuration, the optimal charging position may be efficiently searched, and the number of times of offset processing may be reduced.

Note that the target parking position may not be offset simultaneously in the X direction and the Y direction in all the offset processing. For example, the parking control device may appropriately select the case where the offset processing in the X direction and the offset processing in the Y direction are simultaneously executed and the case where only the offset processing in the X direction (or the Y direction) is executed each time the parking control and the non-contact charging are executed in the parking space 2.

Although one embodiment of the present disclosure has been described above with reference to the accompanying drawings, it is needless to say that the present invention is not limited to the embodiment. It is apparent that those skilled in the art may conceive of various modifications and alterations within the scope described in the claims, and it is understood that such modifications and alterations naturally fall within the technical scope of the present invention. In addition, the components in the above embodiment may be freely combined without departing from the gist of the invention.

For example, in the non-contact power transmission system 1 of the above-described embodiment, the coil provided in the vehicle 10 functions as a power reception unit (that is, the secondary coil), but the coil provided in the vehicle 10 may function as a power transmission unit (that is, the primary coil). In other words, the vehicle 10 in the non-contact power transmission system 1 may be capable of non-contact power feeding that transmits power to the power reception device installed in the parking space 2 in a non-contact manner.

Under this case, each time the parking control and the non-contact power feeding are executed in the parking space 2, the parking control device 30 stores the parking position information in association with power feeding result information (at least one of the power feeding output and the power feeding efficiency) of the vehicle 10 in the storage unit 32 when the non-contact power feeding is executed. Then, the parking control device 30 offsets the target parking position of the parking control executed in the parking space 2 based on the past parking position information and the power feeding result information stored in the storage unit 32.

In the above-described embodiment, the parking control unit 36 offsets the target parking position of the parking control executed next time by a predetermined distance when the parking control and the non-contact charging (or the non-contact power feeding) are executed, but the offset timing is not limited thereto. For example, immediately before the parking control and the non-contact charging (the non-contact power feeding) are executed, the parking control unit 36 may offset the target parking position of the parking control executed the current time by a predetermined distance with reference to the past parking position information and the power feeding result information.

In the present description, at least the following matters are described. In the parentheses, the corresponding constituent elements and the like in the above embodiment are shown as an example, but the present invention is not limited thereto.

(1) A parking control device (parking control device 30) for a vehicle (vehicle 10) capable of non-contact power transmission in which power is transmitted in a non-contact manner between a first coil (first coil 4) disposed in a parking space (parking space 2) and a second coil (second coil 7) provided in the vehicle, the parking control device including:
a parking control unit (parking control unit 36) configured to execute parking control for automatically parking the vehicle in a target parking position where the first coil and the second coil face each other in the parking space; and
a result detection unit (charging result detection unit 37) configured to detect transmission result information (charging result information) of the non-contact power transmission executed at the target parking position, in which
the parking control unit is configured to
   store, in a storage unit (storage unit 32), parking position information (offset amount) of the vehicle during execution of the non-contact power transmission in association with the transmission result information each time the non-contact power transmission is executed in the parking space, and
   offset the target parking position of the parking control executed in the parking space based on past parking position information and the transmission result information stored in the storage unit.

According to (1), even when the target parking position in the control does not coincide with the optimal position of the non-contact power transmission due to the control variation and the like, it is possible to improve the efficiency of the non-contact power transmission by offsetting the target parking position based on the past parking position information and the transmission result information stored in association with each other each time the non-contact power transmission is executed in the parking space.

(2) The parking control device according to (1), in which
the transmission result information includes at least one of a charging output and a charging efficiency, or at least one of a power feeding output and a power feeding efficiency, and
the parking control unit is configured to offset the target parking position of the parking control executed in the parking space to a position where at least one of the charging output and the charging efficiency, or at least one of the power feeding output and the power feeding efficiency is optimal.

According to (2), the optimal position may be searched based on at least one of the output and the efficiency of the non-contact power transmission.

(3) The parking control device according to (1) or (2), in which
the parking control unit is configured to
   offset the target parking position of the parking control executed in the parking space by a predetermined distance each time the non-contact power transmission is executed in the parking space, and store, in the storage unit, the parking position information in association with the transmission result information during execution of the non-contact power transmission, and
   search for an optimal position for the non-contact power transmission in the parking space based on the parking position information and the transmission result information stored in the storage unit.

According to (3), based on the past parking position information and transmission result information stored in association with each other each time the non-contact power transmission is executed in the parking space, the optimal position for the non-contact power transmission in the parking space is searched, and then the target parking position may be set to the optimal position, and therefore, the efficiency of the non-contact power transmission may be improved.

(4) The parking control device according to (3), in which
the parking control unit is configured to
   offset the target parking position in a first direction and search for a position in the first direction of the optimal position, and
   after the position in the first direction of the optimal position is searched and set, offset the target parking position in a second direction perpendicular to the first direction and search for a position in the second direction of the optimal position.

According to (4), the optimal position may be searched with a simple algorithm by performing the offset processing each time for one direction.

(5) The parking control device according to (3), in which
the parking control unit is configured to simultaneously offset the target parking position in a first direction and a second direction perpendicular to the first direction, and search for a position in the first direction and a position in the second direction of the optimal position.

According to (5), by performing the offset processing simultaneously in the first direction and the second direction, the optimal position may be efficiently searched, and the number of times of the offset processing may be reduced.

(6) A parking control method for a vehicle (vehicle 10) capable of non-contact power transmission in which power is transmitted in a non-contact manner between a first coil (first coil 4) provided in a parking space (parking space 2) and a second coil (second coil 7) provided in the vehicle, the parking control method including:
executing parking control for automatically parking the vehicle in a target parking position where the first coil and the second coil face each other in the parking space;
detecting transmission result information of the non-contact power transmission executed at the target parking position;
storing, in a storage unit, parking position information of the vehicle during execution of the non-contact power transmission in association with the transmission result information each time the non-contact power transmission is executed in the parking space; and
offsetting the target parking position of the parking control to be executed in the parking space next time based on past parking position information and the transmission result information stored in the storage unit.

According to (6), even when the target parking position in the control does not coincide with the optimal position of the non-contact power transmission due to the control variation and the like, it is possible to improve the efficiency of the non-contact power transmission by offsetting the target parking position based on the past parking position information and the transmission result information stored in association with each other each time the non-contact power transmission is executed in the parking space.

What is claimed is:

1. A parking control device for a vehicle capable of non-contact power transmission in which power is transmitted in a non-contact manner between a first coil disposed in a parking space and a second coil provided in the vehicle, the parking control device comprising:
a parking control unit configured to execute parking control for automatically parking the vehicle in a target parking position where the first coil and the second coil face each other in the parking space; and
a result detection unit configured to detect transmission result information of the non-contact power transmission executed at the target parking position, wherein
the parking control unit is configured to
store, in a storage unit, parking position information of the vehicle during execution of the non-contact power transmission in association with the transmission result information each time the non-contact power transmission is executed in the parking space, and
offset the target parking position of the parking control executed in the parking space based on past parking position information and the transmission result information stored in the storage unit.

2. The parking control device according to claim 1, wherein
the transmission result information includes at least one of a charging output and a charging efficiency, or at least one of a power feeding output and a power feeding efficiency, and
the parking control unit is configured to offset the target parking position of the parking control executed in the parking space to a position where at least one of the charging output and the charging efficiency, or at least one of the power feeding output and the power feeding efficiency is optimal.

3. The parking control device according to claim 1, wherein
the parking control unit is configured to
offset the target parking position of the parking control executed in the parking space by a predetermined distance each time the non-contact power transmission is executed in the parking space, and store, in the storage unit, the parking position information in association with the transmission result information during execution of the non-contact power transmission, and
search for an optimal position for the non-contact power transmission in the parking space based on the parking position information and the transmission result information stored in the storage unit.

4. The parking control device according to claim 3, wherein
the parking control unit is configured to
offset the target parking position in a first direction and search for a position in the first direction of the optimal position, and
after the position in the first direction of the optimal position is searched and set, offset the target parking position in a second direction perpendicular to the first direction and search for a position in the second direction of the optimal position.

5. The parking control device according to claim 3, wherein
the parking control unit is configured to simultaneously offset the target parking position in a first direction and a second direction perpendicular to the first direction, and search for a position in the first direction and a position in the second direction of the optimal position.

6. A parking control method for a vehicle capable of non-contact power transmission in which power is transmitted in a non-contact manner between a first coil provided in a parking space and a second coil provided in the vehicle, the parking control method comprising:
executing parking control for automatically parking the vehicle in a target parking position where the first coil and the second coil face each other in the parking space;
detecting transmission result information of the non-contact power transmission executed at the target parking position;
storing, in a storage unit, parking position information of the vehicle during execution of the non-contact power transmission in association with the transmission result information each time the non-contact power transmission is executed in the parking space; and
offsetting the target parking position of the parking control to be executed in the parking space next time based on past parking position information and the transmission result information stored in the storage unit.
